(19) United States
(12) Patent Application Publication
(10) Pub. No.: US 2015/0347461 A1
(43) Pub. Date: Dec. 3, 2015

(54) DISPLAY APPARATUS AND METHOD OF PROVIDING INFORMATION THEREOF

(71) Applicant: SAMSUNG ELECTRONICS CO., LTD., Suwon-si (KR)

(72) Inventors: Ji-bum MOON, Seoul (KR); Chang-seog KO, Hwaseong-si (KR); Jean-Christophe NAOUR, Anyang-si (KR); Jae-ki KYOUN, Seoul (KR); Jae-yeop KIM, Seoul (KR); Joon-ho PHANG, Seoul (KR); Ha-yeon YOO, Seongnam-si (KR); Kwan-min LEE, Seoul (KR); Sang-hee LEE, Seoul (KR); Jun-woo LEE, Seoul (KR); Ji-yeon LEE, Seoul (KR); Sung-hyun JANG, Seoul (KR); Seong-wook JEONG, Seoul (KR)

(73) Assignee: SAMSUNG ELECTRONICS CO., LTD., Suwon-si (KR)

(21) Appl. No.: 14/721,584

(22) Filed: May 26, 2015

(30) Foreign Application Priority Data
May 27, 2014 (KR) 10-2014-0063641

(51) Int. Cl. G06F 17/30

(52) U.S. Cl. CPC G06F 17/30256; G06F 17/30554; G06F 17/30572; G06F 17/30864

(57) ABSTRACT

A display apparatus and a method of providing information thereof are provided. The information providing method of the display apparatus includes displaying image content, recognizing at least one of a user motion and a user voice to obtain information related to the image content while the image content is displayed, generating query data according to the recognized at least one of the user motion and the user voice, and transmitting the query data to an external server, and in response to receiving information related to the image content from the external server in response to transmitting the query data, providing the received related information.

### CROSS-REFERENCE TO RELATED APPLICATIONS

This application claims priority from Korean Patent Application No. 10-2014-0063641, filed in the Korean Intellectual Property Office on May 27, 2014, the entire disclosure of which is incorporated herein by reference.

### BACKGROUND

1. Field

Apparatuses and methods consistent with exemplary embodiments relate to a display apparatus and a method of providing information thereof, and more particularly, to a display apparatus which provides information related to image content and a method of providing information thereof.

2. Description of the Related Art

Due to advances in communication technology and a rapid increase in the number of contents provided, users' needs for more information related to the contents are increasing.

In the related art, if a user wants to obtain information related to image content of interest which is being broadcast or played through a display apparatus, the user may search for the related information using another apparatus (such as a smart phone), rather than the display apparatus itself. In this case, the user needs to rely on his or her memory or take a note in order to find the related information.

In addition, in order to check for information related to the current image, the user might need to install and execute applications in a separate mobile terminal.

However, if a user is not sure which information is to be searched, the user may experience difficulties in searching for the information or miss the screen which is currently displayed while trying to search for the information. In addition, relying on one's memory to search for information is also problematic since the information cannot be obtained if the user forgets the information.

### SUMMARY

One or more exemplary embodiments provide a display apparatus configured to obtain information related to image content which is currently displayed using an intuitive interaction such as a user voice and a user motion, and a method of providing information thereof.

According to an aspect of an exemplary embodiment, there is provided a method of providing information performed by a display apparatus, the method including displaying image content on a display screen of the display apparatus, recognizing at least one of a user motion and a user voice to obtain information related to the image content while the image content is displayed, generating query data according to the recognized at least one of the user motion and the user voice, and transmitting the query data to an external server, and in response to receiving information related to the image content from the external server in response to transmitting the query data, providing the received related information.

The transmitting may include analyzing the recognized at least one of the user motion and the user voice, and determining an object of interest from one or more objects displayed on a display screen at a time when the at least one of the user motion and the user voice is recognized, about which related information is to be searched, generating query data including information regarding the object of interest, and transmitting the query data to the external server.

The determining may include, in response to a user voice to obtain information related to the image content being recognized, generating text data according to the user voice, and determining an object of interest about which related information is to be searched using the text data.

The determining may include, in response to a first predetermined user motion being recognized, displaying a pointer on the display screen, in response to a second predetermined user motion being recognized, moving the pointer according to the move command, and in response to a third predetermined user motion being recognized after the pointer is placed on one of a plurality of objects displayed on the display screen, determining that the object where the pointer is positioned is an object of interest of which related information is to be searched.

The providing may include, in response to a request to provide the related information in real time being included in the recognized at least one of the user motion and the user voice, displaying the received related information along with the image content.

The providing may include, in response to a request to store the related information being included in the at least one of the recognized user motion and the user voice, storing the received related information, and in response to a predetermined user command being input, displaying on the display a related information list including the stored related information.

The method may include, in response to an object containing a predetermined related information while the image content is displayed, displaying an informational message, and in response to a user interaction using the informational message being recognized, transmitting query data requesting the predetermined related information to the external server.

The method may include transmitting the received related information to an external mobile terminal.

The query data may include at least one of information regarding a time when the at least one of the user motion and the user voice is recognized, information regarding a screen displayed when one of the user motion and user voice is recognized, and information regarding an audio output when the at least one of the user motion and the user voice is recognized, and the external server may analyze the query data, search related information corresponding to the query data, and transmit the searched related information corresponding to the query data to the display apparatus.

According to an aspect of another exemplary embodiment, there is provided a display apparatus including a display configured to display image content, a motion recognizer configured to recognize a user motion, a voice recognizer configured to recognize a user voice, a communicator configured to perform communication with an external server, and a controller configured to, in response to at least one of the user motion and the user voice to obtain information related to the image content being recognized while the image content is displayed, control the communicator to generate query data according to at least one of the user motion and the user voice and transmit the query data to an external server, and in response to information related to the image content being received from the external server in response to the query data, provide the received related information.

The controller may control the communicator to determine an object of interest from one or more objects displayed on a display screen at a time when the at least one of the user motion and the user voice is recognized, about which related information is to be searched by analyzing at least one of the recognized user motion and user voice, generate query data including information regarding the object of interest, and transmit the query data to the external server.

The controller, in response to a user voice to obtain information related to the image content being recognized, may generate text data according to the words spoken by the user voice, and determine an object of interest of which related information is to be searched using the text data.

The controller, in response to a first predetermined user motion being recognized, may control the display to display a pointer on a display screen of the display, in response to a second predetermined user motion being recognized, moves the pointer according to a move command, and in response to a third predetermined user motion being recognized after the pointer is placed on one of a plurality of objects displayed on the display screen, may determine that the object where the pointer is positioned as an object of interest of which related information is to be searched.

The controller, in response to a request to provide the related information in real time being included in at least one of the recognized user motion and user voice, may control the display to display the received related information along with the image content.

The display apparatus may further include a storage, and the controller, in response to a request to store the related information being included in the recognized at least one of the user motion and the user voice, may store the received related information, and in response to a predetermined user command being input, may control the display to display a related information list including the stored related information.

The controller, in response to an object containing a predetermined related information being recognized while the image content is displayed, may control the display to display an informational message, and in response to a user interaction using the informational message being recognized, may control the communicator to transmit query data requesting the predetermined related information to the external server.

The controller may control the communicator to transmit the received related information to an external mobile terminal.

The query data may include at least one of information regarding a time when the at least one of the user motion and the user voice is recognized, information regarding a screen displayed by the display when one of the user motion and user voice is recognized, and information regarding an audio output when the at least one of the user motion and the user voice is recognized, and the external server may analyze the query data, search related information corresponding to the query data, and transmit the searched related information corresponding to the query data to the display apparatus.

According to an aspect of another exemplary embodiment, there is provided an apparatus for displaying information related to image content, the apparatus including a display configured to display the image content, and a controller configured to control the display to display the information related to the image content on the display according to at least one of a user voice and a user motion being recognized by at least one of a voice recognizer and a motion recognizer.

The apparatus may further include wherein the information related to the image content is at least one of image information, related music information, shopping information, image-related news information, social network information, and advertisement information.

The apparatus may further include a communicator configured to communicate with an external server, and wherein the controller controls the communicator to generate query data according to the recognized at least one of the user motion and the user voice, and transmits the query data to the external server, and wherein the controller controls the communicator to receive the information related to the image content from the external server.

The apparatus may further include wherein the query data includes the image content on the display at the time when the at least one of the user motion and the user voice is recognized.

The apparatus may further include wherein the controller controls the communicator to transmit the received the information related to the image content to an external mobile terminal.

### BRIEF DESCRIPTION OF THE DRAWINGS

The above and/or other aspects will be more apparent by describing certain exemplary embodiments with reference to the accompanying drawings, in which:

FIG. 1 is a view illustrating an information providing system according to an exemplary embodiment;

FIG. 2 is a block diagram illustrating a configuration of a display apparatus briefly according to an exemplary embodiment;

FIG. 3 is a block diagram illustrating a configuration of a display apparatus in detail according to an exemplary embodiment;

FIGS. 4A to 4E are views provided to illustrate an exemplary embodiment in which related information is stored and provided later according to an exemplary embodiment;

FIGS. 5A to 5D are views provided to illustrate an exemplary embodiment in which related information is provided in real time according to an exemplary embodiment;

FIGS. 6A to 6C and 7A to 7C are views provided to illustrate exemplary embodiments in which information related to an object of interest is provided;

FIGS. 8A to 8C are views provided to illustrate an exemplary embodiment in which an informational message showing an object for which related information is stored is provided;

FIGS. 9A to 9C are views provided to illustrate an exemplary embodiment in which related information is provided using an external mobile terminal;

FIG. 10 is a flowchart provided to explain an information providing method of a display apparatus according to an exemplary embodiment; and

FIGS. 11 and 12 are sequence views provided to explain information providing methods of an information providing system according to various exemplary embodiments.

### DETAILED DESCRIPTION

The exemplary embodiments may vary, and may be provided in different exemplary embodiments. Specific exemplary embodiments will be described with reference to accompanying drawings and detailed explanation. However, this does not necessarily limit the scope of the exemplary embodiments to a specific embodiment form. Instead, modifications, equivalents and replacements included in the disclosed concept and technical scope of this specification may be employed. Expressions such as “at least one of,” when preceding a list of elements, modify the entire list of elements and do not modify the individual elements of the list.

In the present disclosure, relational terms such as first and second, and the like, may be used to distinguish one entity from another entity, without necessarily implying any actual relationship or order between such entities.

The terms used in the following description are provided to explain a specific exemplary embodiment and are not intended to limit the scope of rights. A singular term includes a plural form unless it is expressly intended to be a singular form. The terms, “include”, “comprise”, “is configured to”, etc. of the description are used to indicate that there are features, numbers, steps, operations, elements, parts or combination thereof, and they should not exclude the possibilities of combination or addition of one or more features, numbers, steps, operations, elements, parts or combination thereof.

In an exemplary embodiment, ‘a module’ or ‘a unit’ performs at least one function or operation, and may be realized as hardware, such as a processor or integrated circuit, software that is executed by a processor, or a combination thereof. In addition, a plurality of ‘modules’ or a plurality of ‘units’ may be integrated into at least one module and may be realized as at least one processor except for ‘modules’ or ‘units’ that should be realized in a specific hardware.

In an exemplary embodiment, it is assumed that a user terminal refers to a user terminal in a mobile or fixed form, such as a User Equipment (UE), a Mobile Station (MS), an Advance Mobile Station (AMS), a device, etc.

Hereinafter, an exemplary embodiment will be described in detail with reference to accompanying drawings. In the following description, same reference numerals are used for analogous elements when they are depicted in different drawings, and overlapping description will be omitted.

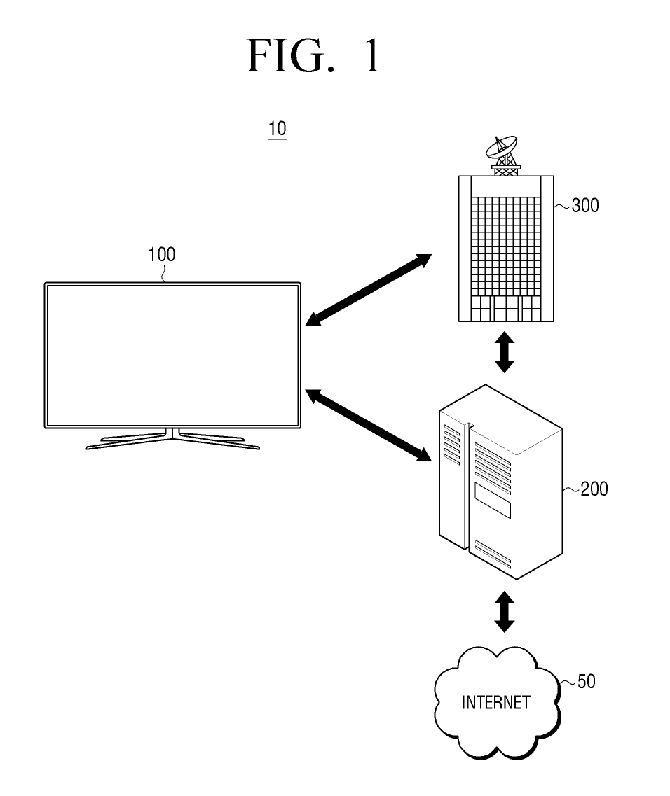

FIG. 1 is a view illustrating an information providing system 10 according to an exemplary embodiment. As illustrated in FIG. 1, the information providing system 10 includes a display apparatus 100, a related information providing server 200, a broadcast station 300, and Internet 50. In this case, the display apparatus 100 is a smart television but this is only an example. The display apparatus 100 may be realized as various display apparatuses such as a smart phone, a tablet personal computer (PC), a notebook PC, a digital television (TV), a desktop PC, etc.

The broadcast station 300 broadcasts content to the display apparatus 100. In addition, the broadcast station 300 provides information regarding broadcast content to the related information providing server 200 in order to generate related information.

The display apparatus 100 displays broadcast content received from the broadcast station 300. In this case, the display apparatus 100 may display not only broadcast content received from the broadcast station 300 but also video on demand (VOD) contents, and various other image contents received from an external apparatus (for example, a DVD player).

If a user interaction to obtain related information (for example, a user motion and/or a user voice) is detected or recognized while image content is displayed, the display apparatus 100 generates query data according to the recognized user interaction. In this case, the query data may include at least one of information regarding a time when the user interaction is recognized, information regarding a screen displayed when the user interaction is recognized, and information regarding an audio output when the user interaction is recognized.

In addition, the display apparatus 100 may determine an object of interest of which related information is to be obtained by analyzing the recognized user interaction, and generate query data including information regarding the determined object of interest.

Subsequently, the display apparatus 100 transmits the generated query data to the external related information providing server 200.

The related information providing server 200 searches related information corresponding to the received query data using databases where related information matched with time, image, and audio information is stored. In addition, the related information providing server 200 transmits the searched related information corresponding to the query data to the display apparatus 100.

When the related information is received by the display apparatus 100, the display apparatus 100 provides the related information to a user. In this case, the display apparatus 100 may provide the user with the related information in various ways by analyzing the recognized user interaction. For example, if a user interaction to store the related information is recognized, the display apparatus 100 may store the related information received from the related information providing server 200, and provide the user with a related information list including the stored related information in response to a user command later. Alternatively, if a user interaction to display related information in real time is recognized, the display apparatus 100 may display related information received from the related information providing server 200 along with image content.

In addition, the display apparatus 100 may transmit the received related information to an external mobile terminal and the external mobile terminal may display the received related information.

According to the above-described information providing system, a user may obtain information related to the screen or object of image content which is currently displayed more easily and intuitively.

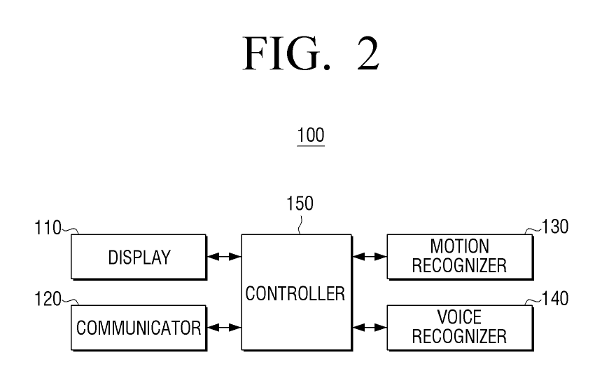

Hereinafter, the display apparatus 100 will be described in greater detail with reference to FIGS. 2 to 9C. FIG. 2 is a block diagram illustrating configuration of the display apparatus 100 briefly according to an exemplary embodiment. As illustrated in FIG. 2, the display apparatus 100 includes a display 110, a communicator 120, a motion recognizer 130, a voice recognizer 140, and a controller 150.

The display 110 may display image content received from an external source. For example, the display 110 may display broadcast content received from the external broadcast station 300.

The communicator 120 performs communication with various external apparatuses. For example, the communicator 120 may transmit query data to the external related information providing server 200, and obtain related information which responds to the query data from the related information providing server 200. In addition, the communicator 120 may transmit the related information to an external mobile terminal.

The motion recognizer 130 may recognize a user motion using a camera or other video recording device. For example, the motion recognizer 130 may recognize a predetermined user motion to obtain related information.

The voice recognizer 140 may recognize a user voice input through a microphone or other sound recording device. For example, the voice recognizer 140 may recognize a predetermined user voice command to obtain related information.

The controller 150 controls overall operations of the display apparatus 100. For example, if a user motion and/or a user voice to obtain information related to image content is recognized from the motion recognizer 130 and/or the voice recognizer 140 while the image content is displayed, the controller 150 may control the communicator 120 to generate query data according to the recognized user motion and/or user voice, and transmit the query data to the related information providing server 200. If the information related to the image content is received from the related information providing server 200 through the communicator 120 in response to the query data, the controller 150 may provide the received related information.

If a user motion and/or a user voice to obtain related information is recognized, the controller 150 may generate query data, which may include information regarding image content at a time when the user motion and/or the user voice is recognized. In this case, the query data may include at least one of information regarding a time when the user motion and/or the user voice is recognized, information regarding a screen displayed when the user motion and/or the user voice is recognized (for example, information regarding a plurality of image frames before and after a time when the user motion and/or the user voice is recognized), and information regarding an audio output when the user motion and/or the user voice is recognized (for example, information regarding an audio output to a plurality of image frames before and after a time when the user motion and/or user voice is recognized).

In addition, if a user motion and/or user voice is recognized, the controller 150 may analyze the user motion and/or user voice and identify at least one of the objects displayed on the screen when the user motion and/or user voice is recognized, as an object of interest of which related information is to be searched.

In an exemplary embodiment, if a user voice to obtain information related to image content is recognized, the controller 150 may generate text data by analyzing the user voice, and search an object of interest of which related information is to be searched using the text data. In another exemplary embodiment, if a predetermined user motion (for example, a motion of waving a hand in left and right directions a plurality of times) is recognized, the controller 150 may control the display 110 to display some feature. For example, the display 110 may display a pointer on a display screen. Subsequently, if a command, e.g., to move the pointer, is recognized through the motion recognizer 130, the controller 150 may move the pointer according to the move command. If a selection command is recognized through the motion recognizer 130 after the pointer is positioned on one of a plurality of objects displayed in the display 110, the controller 150 may determine the object where the pointer is positioned as an object of interest of which related information is to be searched. The examples above and throughout the specification are merely exemplary and a person having ordinary skill in the art will understand that many other variations are possible regarding the voice and motion commands. In most of the above-described exemplary embodiments, an object of interest is determined using one of a user motion and a user voice, but this is only an example. An object of interest may be determined using both a user motion and a user voice.

If an object of interest is determined, the controller 150 may generate query data including information regarding the object of interest, and transmit the generated query data to the related information providing server 200. The information regarding the object of interest may include information regarding at least one of the name, display time, image, and audio of the object of interest.

Subsequently, the controller 150 may control the communicator 120 to receive related information in response to the query data from the related information providing server 200.

The controller 150 may control the display 110 to display the received related information. In short, the controller 150 may analyze the recognized user motion and/or user voice and provide related information in many different ways.

Specifically, if a request to provide the related information in real time is included in the recognized user motion and/or user voice, the controller 150 may control the display 110 to display the received related information along with the image content which is displayed currently. Alternatively, if a request to store related information is included in of the recognized user motion and/or user voice, the controller 150 may store the received related information. In response to a predetermined user command to generate a related information list, the controller 150 may control the display 110 to display the related information list including stored related information.

A displayed object may contain predetermined related information, whereby when an object is recognized while image content is displayed, the controller 150 may control the display to display an informational message providing related information about the object. A user may interact with the displayed informational message through a user motion and/or user voice. In response to the user motion and/or user voice being recognized, the controller 150 may control the communicator 120 to transmit query data requesting predetermined related information to the related information providing server 200.

In addition, the controller 150 may control the communicator 120 to transmit the received related information to an external mobile terminal so that the current image content can be continuously played. Accordingly, a user may search related information while watching the image content continuously.

According to the above-described display apparatus 200, a user may search information related to a screen or an object to be searched more intuitively and conveniently using a user motion and/or a user voice.

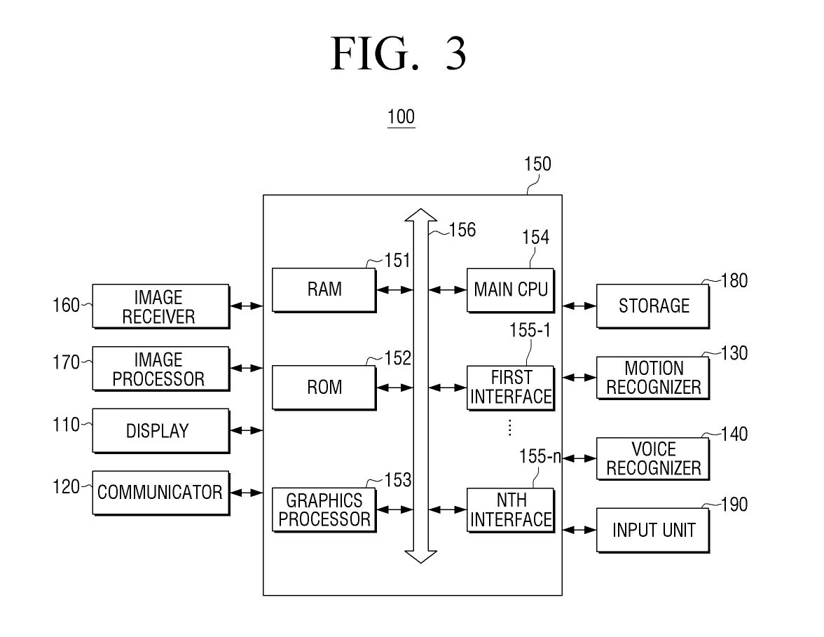

FIG. 3 is a block diagram illustrating configuration of the display apparatus 100 in detail according to an exemplary embodiment. As illustrated in FIG. 3, the display apparatus 100 includes the display 110, the communicator 120, a storage 180, the motion recognizer 130, the voice recognizer 140, an input unit 190, and the controller 150.

An image receiver 160 receives image content from various sources. For example, the image receiver 160 may receive broadcast content from the external broadcast station 300. In addition, the image receiver 160 may receive a VOD content from Internet 50. The image receiver 160 may also receive image content from an external apparatus (for example, a DVD player).

The image processor 170 processes image data received from the image receiver 160. The image processor 170 may perform various image processing with respect to image data, such as decoding, scaling, noise filtering, frame rate conversion, resolution conversion, etc.

The display 110 displays at least one of a video frame which is generated when the image processor 170 processes image data received from the image receiver 160 and various screens generated by a graphics processor 153. The display 110 may also display related information while image content received through the image receiver 160 is displayed. In addition, the display 110 may display a related information list including stored related information in response to the control of the controller 150.

The communicator 120 communicates with various types of external apparatuses according to various types of communication methods. The communicator 120 may include various communication chips such as a WiFi chip, a Bluetooth chip, a Near Field Communication (NFC) chip, a wireless communication chip, and so on. The WiFi chip, the Bluetooth chip, and/or the NFC chip may perform communication according to a WiFi method, a Bluetooth method, and an NFC method, respectively. Among the above chips, the NFC chip represents a chip which may operate according to an NFC method which uses 13.56 MHz band among various RF-ID frequency bands such as 135 kHz, 13.56 MHz, 433 MHz, 860-960 MHz, 2.45 GHz, or other frequencies. In the case of the WiFi chip or the Bluetooth chip, various connection information such as SSID and a session key may be transmitted/received first for communication connection and then, various information may be transmitted/received. The wireless communication chip represents a chip which performs communication according to various communication standards such as IEEE, Zigbee, 3^{rd} Generation (3G), 3^{rd} Generation Partnership Project (3GPP), Long Term Evolution (LTE) and so on.

For example, the communicator 120 may perform communication with the external related information providing server 200. Specifically, the communicator 120 may transmit query data including information regarding a screen or an object of interest to the related information providing server 200, and receive the related information from the related information providing server 200.

In addition, the communicator 120 may transmit the related information to an external mobile terminal. If it operates with a mobile terminal using a mirroring mode, the communicator 120 may transmit image content to the mobile terminal in real time.

The storage 180 stores various modules to drive the display apparatus 100. For example, the storage 180 may store various software modules including a base module, a sensing module, a communication module, a presentation module, a web browser module, and a service module. The base module may refer to a basic module which processes a signal transmitted from each piece of hardware included in the display apparatus 100, and transmits the processed signal to an upper layer module. The sensing module may be a module which collects information from various sensors, and analyzes and manages the collected information. The sensing module may include a face recognition module, a voice recognition module, a motion recognition module, and/or an NFC recognition module, etc. The presentation module may be a module to create a display screen. The presentation module may include a multimedia module for reproducing and outputting multimedia contents, and a user interface (UI) rendering module for UI and graphic processing. The communication module may be a module to perform communication with outside. The web browser module may refer to a module which accesses a web server by performing web-browsing. The service module is a module including various applications for providing various services.

As described above, the storage 180 may include various program modules, but some of the various program modules may be omitted, changed, or added according to the type and characteristics of the display apparatus 100. For example, in response to the display apparatus 100 being realized as a tablet PC, the base module may further include a determination module to determine a GPS-based location, and the sensing module may further include a sensing module to sense the operation of a user.

In addition, the storage 180 may store related information received from the external related information providing server 200.

The motion recognizer 130 recognizes a user motion by analyzing a user motion photographed by a camera using a motion recognition module and motion database. In this case, the motion recognizer 130 may recognize a predetermined user motion to obtain related information.

The voice recognizer 140 recognizes a user motion by analyzing a voice uttered by a user, which is received through a microphone using a voice recognition module and voice database. In this case, the voice recognizer 140 may recognize a predetermined user voice to obtain related information.

The input unit 180 may receive a user command to control the operation of the display apparatus 100. In this case, the input unit 180 may be realized as a remote controller having a plurality of buttons or a touch sensor, but this is only given as one example. The input unit 180 may be realized by various input apparatuses such as a pointing device, a touch screen, a mouse, a keyboard, etc.

The controller 150 controls overall operation of the display apparatus 100 using various programs stored in the storage 180.

As illustrated in FIG. 3, the controller 150 includes a random access memory (RAM) 151, a read only memory (ROM) 152, a graphics processor 153, a main central processing unit (CPU) 154, a first to nth interfaces 155-1-155-n, and a bus 156. In this case, the RAM 151, the ROM 152, the graphics processor 153, the main CPU 154, and the first to nth interfaces 155-1-155-n may be connected to each other through the bus 156.

The ROM 152 stores a set of commands for system booting. If a turn-on command is input and power is supplied, the main CPU 134 copies an operating system (0/S) stored in the storage 180 onto the CPU 134 according to a command stored in the ROM 132 and boots a system by executing the 0/S. If the booting is completed, the main CPU 154 copies various application programs stored in the storage 180 onto the RAM 151 and performs the various operations by executing the application programs copied in the RAM 151.

The graphics processor 153 generates a screen including various objects such as an icon, an image, and a text using a computing unit and a rendering unit. The computing unit may compute values for attributes such as coordinates, shape, size, and color of each object to be displayed according to the layout of the screen using a control command received from the input unit 380. The rendering unit may generate a screen with various layouts including objects based on the property values computed by the computing unit. The screen generated by the rendering unit is displayed within the display area of the display 110.

The main CPU 154 accesses the storage 180, and performs booting using an operating system stored in the storage 180, and performs various operations using various programs, contents, and data stored in the storage 180.

The first to nth interfaces 155-1-155-n are connected to the above-described various components. One of the interfaces may be a network interface which is connected to an external apparatus via network.

For example, if a user motion and/or a user voice to obtain information related to image content is recognized from the motion recognizer 130 and/or the voice recognizer 140 while the image content is displayed, the controller 150 may control the communicator 120 to generate query data according to the recognized user motion and/or user voice and transmit the query data to the related information providing server 200. If the related information of the image content is received from the related information providing server 200 in response to the query data, the controller 150 provides the received related information.

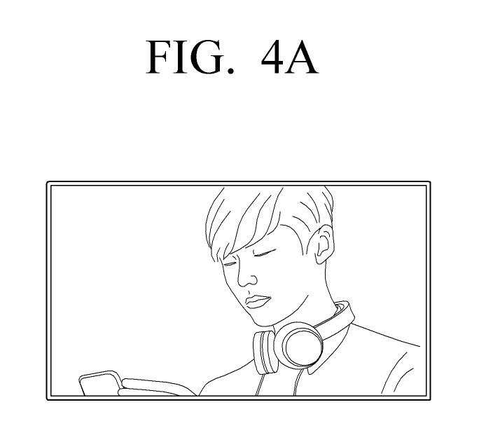

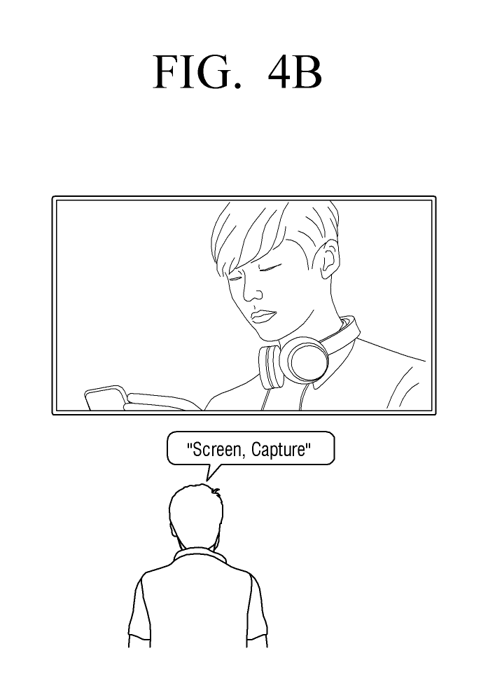

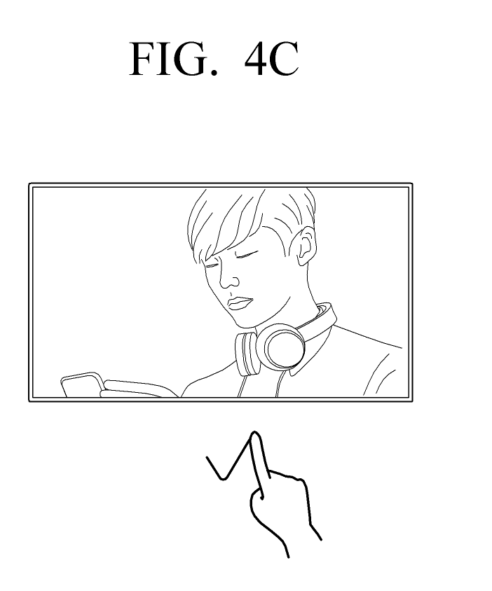

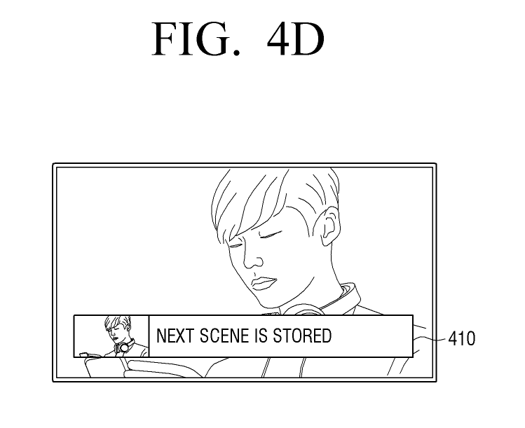

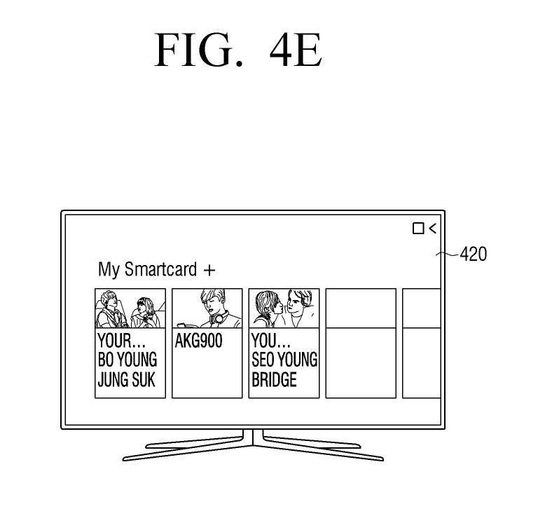

Hereinafter, various exemplary embodiments will be described with reference to FIGS. 4A to 9C.

FIGS. 4A to 4E are views provided to illustrate an exemplary embodiment in which related information is stored and provided later according to an exemplary embodiment.

First of all, the controller 150 may control the display 110 to display image content as illustrated in FIG. 4A.

If a user motion and/or a user voice to store related information is recognized on the screen of image content, the controller 150 may analyze the screen when a user motion and/or a user voice is recognized and generate query data.

For example, as illustrated in FIG. 4B, if a user voice of “Screen, Capture” is input while image content is displayed, the voice recognizer 140 may recognize the input user voice and output text data to the controller 150. The controller 150 may determine that the input user voice is a user voice to store related information regarding the screen of the image content based on the output text data, and generate query data by analyzing the screen when the user voice is recognized.

In another example, as illustrated in FIG. 4C, if a user motion in the shape of “V” is input while image content is displayed, the motion recognizer 130 may recognize the input user motion and output the recognition result to the controller 150. The controller 150 may determine for example that the input user motion is a user motion to store related information regarding the screen of the image content based on the recognition result, and generate query data by analyzing the screen when the user voice is recognized.

For example, the controller 150 may generate query data based on at least one of time information, image information and audio information regarding the time when at least one of a user motion and a user voice is recognized. For example, the controller 150 may generate query data including time information that one of a user motion and a user voice is recognized 31 minutes after image content is played, and image data and audio data within a predetermined time period (for example, before and after 10 frames) from the time when one of the user motion and the user voice is recognized.

In addition, the controller 150 may capture the screen when at least one of a user motion and a user voice is recognized and store the screen in the storage 180, and may control the display 110 to display a UI 410 as illustrated in FIG. 4D.

Subsequently, the controller 150 may control the communicator 120 to transmit the generated query data to the related information providing server 200.

The related information providing server 200 may search related information corresponding to the generated query data. Specifically, the related information providing server 200 may match related information corresponding to the specific time, specific image, and specific audio of image content and store the same in database. If query data is received from the display apparatus 100, the related information providing server 200 may parse the query data, and search related information using one of time information, image information, and audio information when one of a user voice and a user motion is recognized. In addition, the related information providing server 200 may search related information through various sources such as external Internet 50. If related information is searched, the related information providing server 200 may transmit the searched related information to the display apparatus 100. According to an exemplary embodiment, the related information may include at least one of image information, related music information, shopping information, image-related news information, social network information, and advertisement information. The related information may be realized in various ways such as image, audio, text, and website link.

If related information is received, the controller 150 may store the received related information in the storage 180 along with a captured screen.

If a command to generate a related information list is input through the input unit 190, the controller 150 may control the display 110 to display a related information list 420 as illustrated in FIG. 4E. A user may check related information regarding the screen displayed when one of a user motion and a user voice is recognized through the related information list 420.

In the above exemplary embodiment, related information regarding a screen is stored using one of a user motion and a user voice, but this is only an example. The technical feature of the present inventive concept may also be applied to an exemplary embodiment where information related to an object of interest, which is included in the screen, is stored.

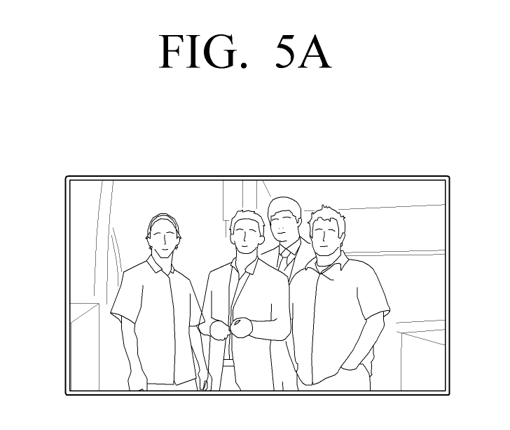

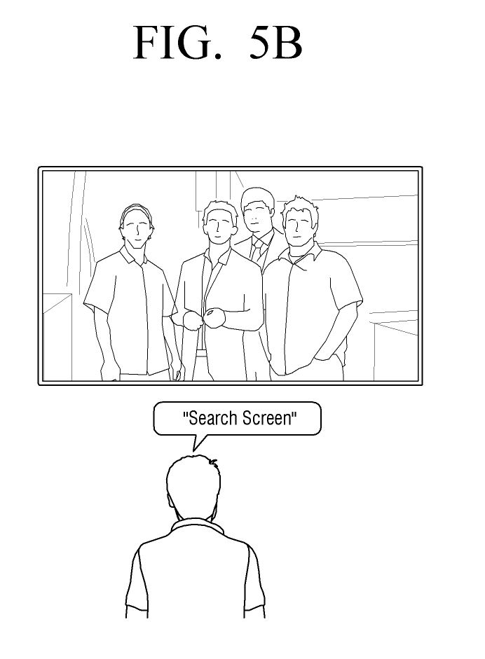

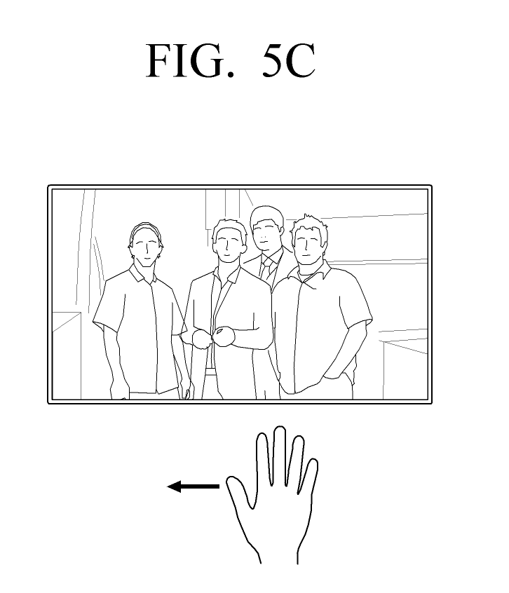

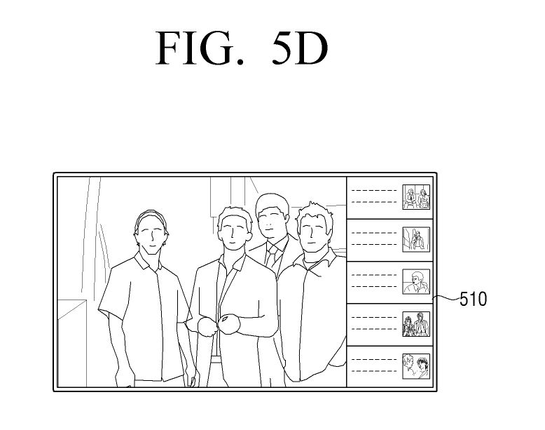

FIGS. 5A to 5D are views provided to illustrate an exemplary embodiment in which related information is provided in real time according to an exemplary embodiment.

First of all, the controller 150 controls the display 110 to display image content as illustrated in FIG. 5A.

If a user motion and/or a user voice to provide information regarding the image content in real time is recognized, the controller 150 may generate query data by analyzing the screen displayed when one of the user motion and the user voice is recognized.

For example, if a user voice of “Search, Screen” is input while image content is displayed as illustrated in FIG. 5B, the voice recognizer 140 may recognize the input user voice, and output text data to the controller 150. Subsequently, the controller 150 may determine that the input user voice is a user voice to provide information related to the screen of the image content in real time based on the output text data, and generate query data by analyzing the screen displayed when the user voice is recognized.

In another example, if a slap, or waving, motion in the left direction is input as illustrated in FIG. 5C while image content is displayed, the motion recognizer 130 may recognize the input user motion and output the recognition result to the controller 150. Subsequently, the controller 150 determines that the input user motion is a user motion to provide information related to the screen of the image content in real time based on the recognition result, and generate query data by analyzing the screen displayed when the user motion is recognized.

For example, the controller 150 may generate query data based on at least one of time information, image information, and audio information at a time when one of a user motion and a user voice is recognized.

The controller 150 may control the communicator 120 to transmit the generated query data to the related information providing server 200.

The related information providing server 200 may search related information corresponding to the generated query data, and transmit the searched related information to the display apparatus 100.

If the related information is received, the controller 150 may control the display 110 to display a related information UI 510 including the received related information. In this case, the related information UI 510 may include at least one of image information, Original Sound Track information, shopping item information, related-news information, Social Networking Site information, and advertisement information, which is related to the screen displayed when one of a user voice and a user motion is recognized.

A user may use information related to the screen which is currently displayed in real time using the related information UI 510.

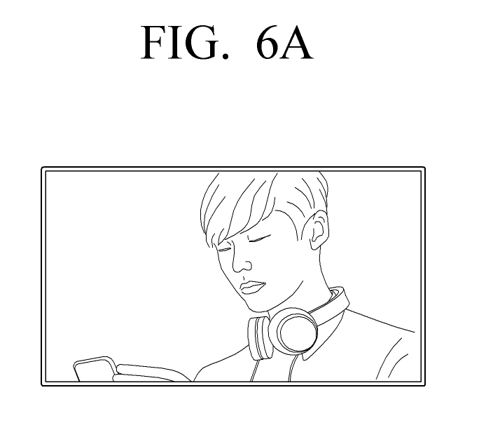

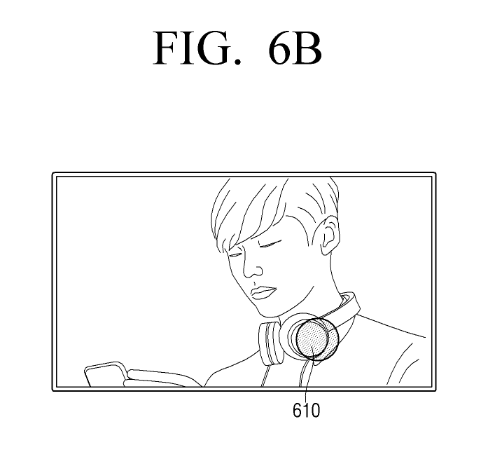

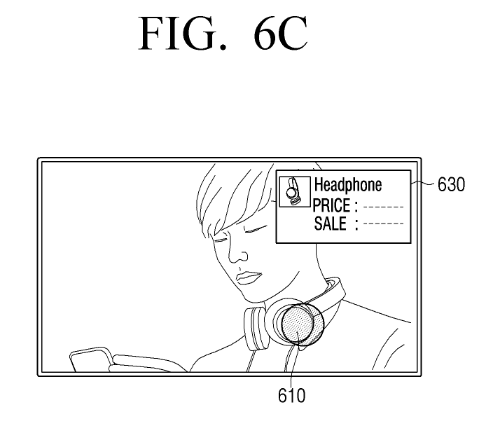

FIGS. 6A to 6C are views provided to illustrate an exemplary embodiment in which information regarding an object of interest is provided according to various exemplary embodiments.

First of all, the controller 150 may control the display 110 to display image content as illustrated in FIG. 6A.

If a predetermined user motion (for example, a motion of waving a hand in left and right directions a plurality of times is recognized through the motion recognizer 130, the controller 150 may control the display 110 to display a pointer 610 on the display screen.

Subsequently, if a user motion to move the pointer 610 is recognized through the motion recognizer 130, the controller 150 may control the display 110 to move the pointer according to the user motion.

As illustrated in FIG. 6B, if a user motion to select an object is recognized through the motion recognizer 130 while the pointer 610 is positioned on an object of interest which is a headphone as illustrated in FIG. 6B, the controller 150 may analyze the user motion and determine that the headphone on the display screen is an object of interest.

The controller 150 may generate query data including information regarding the determined object of interest. Specifically, the controller 150 may generate query data including at least one of play time information regarding a time when a user motion is input, image information regarding an object of interest, and audio information regarding an object of interest.

The controller 150 may control the communicator 120 to transmit the generated query data to the related information providing server 200, and receive related information regarding “headphone” which is an object of interest in response to the query data from the related information providing server 200.

The controller 150, as illustrated in FIG. 6C, may control the display 110 to display a related information UI 630 providing related information regarding “headphone” which is an object of interest.

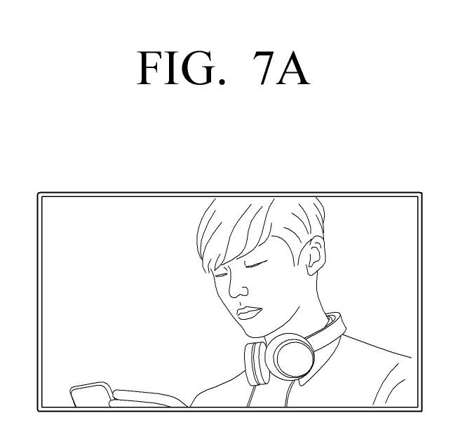

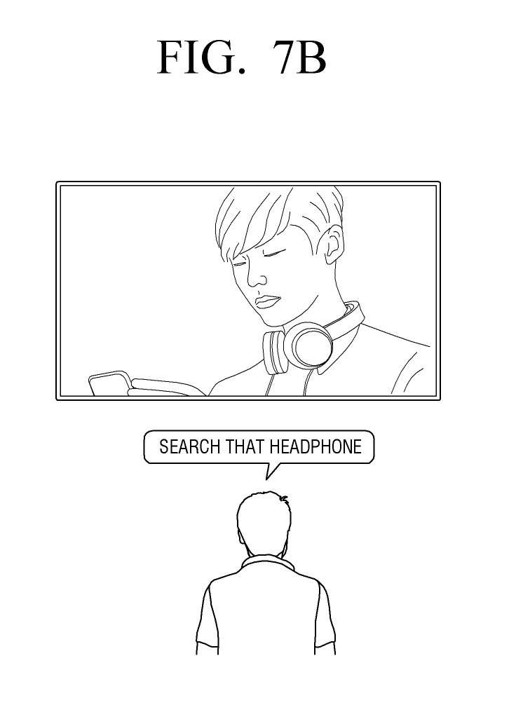

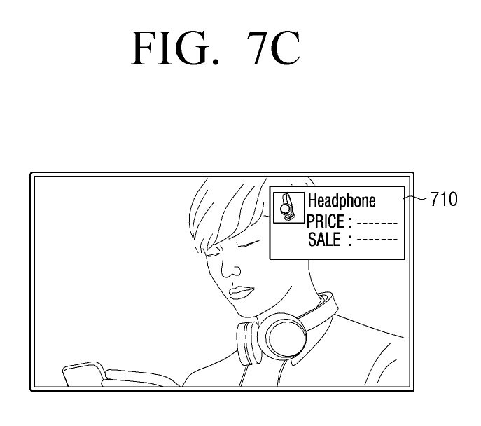

FIGS. 7A to 7C are views provided to illustrate an exemplary embodiment in which information related to an object of interest is provided using a user motion according to various exemplary embodiments.

First of all, the controller 150 may control the display 110 to display image content as illustrated in FIG. 7A.

As illustrated in FIG. 7B, if a user voice of “Search that headphone.” is recognized through the voice recognizer 140 while the image content is displayed, the controller 150 may receive text data based on the voice recognized through the voice recognizer 140.

The controller 150 may determine “headphone” as an object of interest using the text data.

The controller 150 generates query data including information regarding the determined object of interest. Specifically, the controller 150 may generate query data including at least one of play time information regarding a time when a user motion is input, text information regarding an object of interest, and audio information regarding an object of interest.

The controller 150 may control the communicator 120 to transmit the generated query data to the related information providing server 200, and receive information related to “headphone” which is an object of interest in response to the query data from the related information providing server 200.

As illustrated in FIG. 7C, the controller 150 may control the display 110 to display a related information UI 730 providing information regarding “headphone” which is an object of interest.

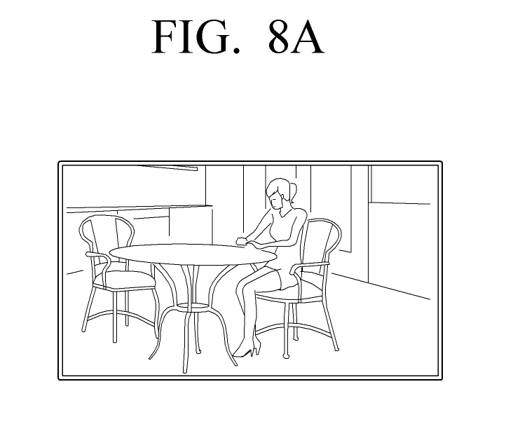

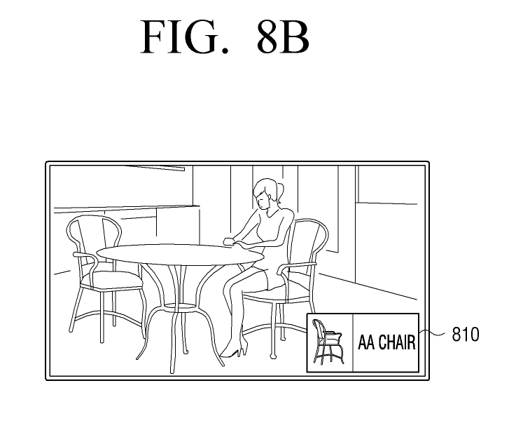

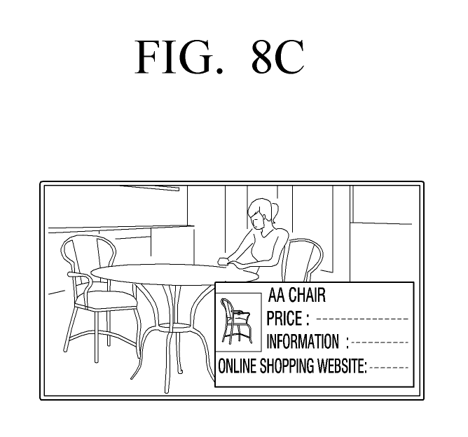

FIGS. 8A to 8C are views provided to illustrate an exemplary embodiment in which an informational message guiding an object for which related information is stored is provided according to an exemplary embodiment.

First of all, the controller 150 may control the display 110 to display image content as illustrated in FIG. 8A. The image content may include event data regarding an object for which predetermined related information is stored.

If a time including event data regarding an object for which predetermined related information is stored arrives while the image content is displayed, the controller 150 controls the display 110 to display an informational message 810 showing an object for which predetermined related information is stored.

For example, if an object of “chair” for which predetermined related information is stored is displayed while image content is displayed, the controller 150 may control the display 110 to display the informational message 810 showing information related to the chair. In this case, the informational message 810 may include brief information regarding the “chair” (for example, the name of product, price, and so on).

If a user interaction using the informational message 810 (for example, a user voice such as “search”, a user motion of waving a hand, an interaction of selecting a predetermined button on a remote controller, and so on) is recognized, the controller 150 may control the communicator 120 to transmit query data requesting predetermined related information to the related information providing server 200.

If related information is received from the related information providing server 200, the controller 150 may control the display 110 to display detailed related information 820 (for example, name of product, price, information on seller, information on purchasing website, etc.) of an object for which predetermined related information is stored as illustrated in FIG. 8C.

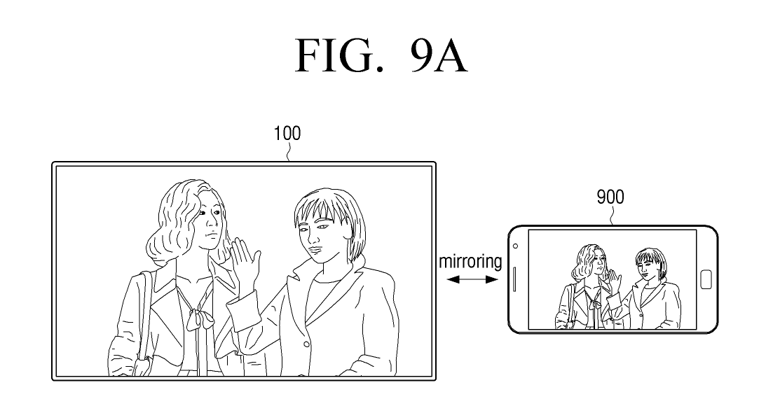

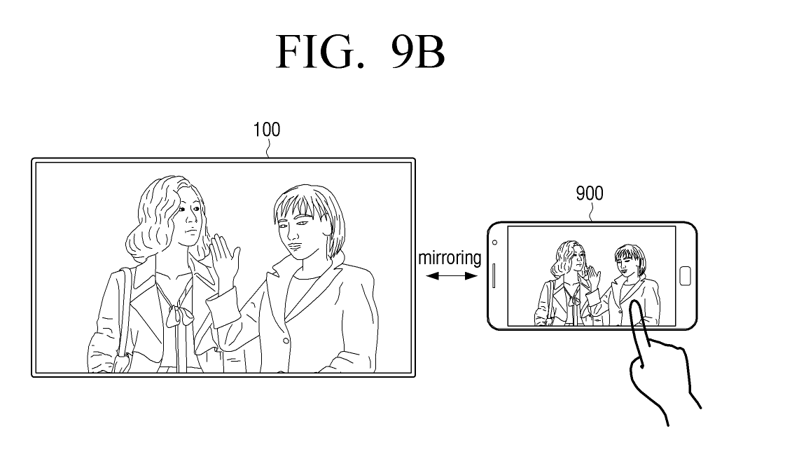

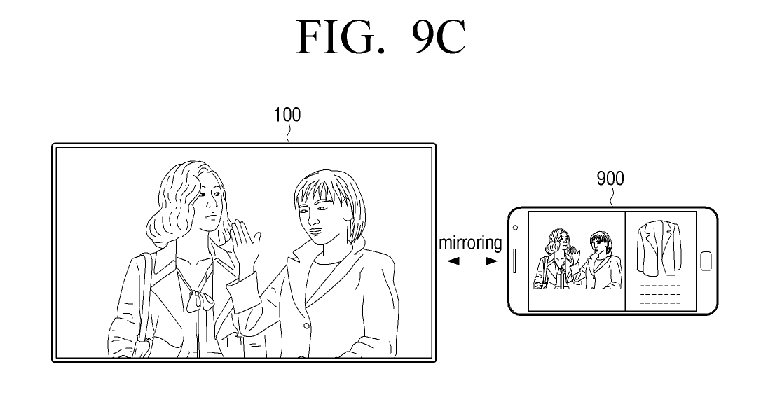

FIGS. 9A to 9C are views provided to illustrate an exemplary embodiment in which related information is provided using an external mobile terminal according to an exemplary embodiment.

The controller 150 controls the display 110 to display image content. For example, if an operation is performed in a mirroring mode, the controller 150 may control the communicator 120 to transmit the image content displayed on the display 110 to a mobile terminal 900 as illustrated in FIG. 9A. The feature that the display apparatus 100 transmits the image content to the mobile terminal 900 in the minoring mode is only an example. For example, the mobile terminal 900 may receive image content directly from an external source, and the mobile terminal 900 may transmit the image content to the display apparatus 100.

If one area of the image content is touched in the minoring mode as illustrated in FIG. 9B, the mobile terminal 900 may determine an object of interest based on information regarding the touched area, and generate query data including the information regarding the object of interest.

The mobile terminal 900 may transmit the generated query data to the related information providing server 200, and receive related information regarding the object of interest from the related information providing server 200 in response to the query data.

In addition, the mobile terminal 900 may display information related to the object of interest as illustrated in FIG. 9C. In this case, if a predetermined user command is input in the mobile terminal 900, the mobile terminal 900 may transmit the information related to the object of interest to the display apparatus 100, and the display apparatus 100 may display the information related to the object of interest.

Through the above-described exemplary embodiments, a user may search a content related to an object of interest using the external mobile terminal 900 without it interfering with the user watching image content through the display apparatus 100.

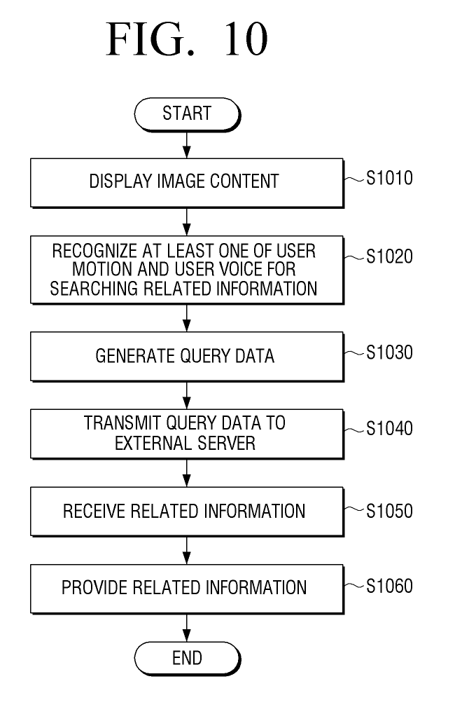

FIG. 10 is a flowchart provided to explain an information providing method of the display apparatus 100 according to an exemplary embodiment.

First of all, the display apparatus 100 displays image content (S1010).

The display apparatus 100 recognizes a user motion and/or a user voice to search related information (S1020).

The display apparatus 100 generates query data according to the recognized user motion and/or user voice (S1030). In this case, the query data may include information regarding a screen or an object which is analyzed through a user motion and/or a user voice.

The display apparatus 100 may transmit the query data to an external server (S1040). The display apparatus 100 receives related information from the external server in response to the query data (S1050).

The display apparatus 100 provides the related information (S1060). In this case, the display apparatus 100 may provide a related information list after storing related information according to the recognized user motion and/or user voice or may display a related information UI in real time along with image content.

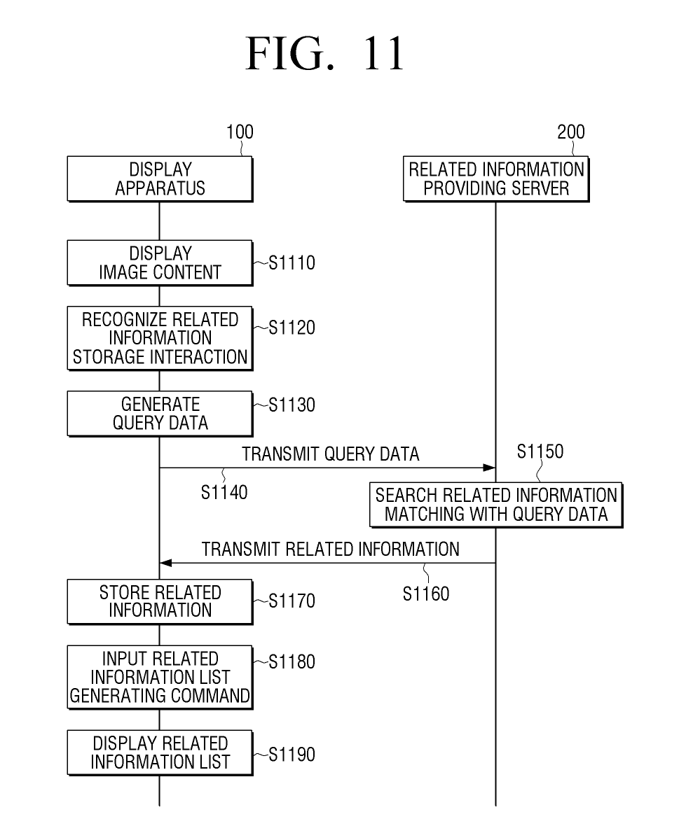

FIG. 11 is a sequence view provided to explain an exemplary embodiment where the information providing system 10 stores related information and provides the related information later.

First, the display apparatus 100 displays image content (S1110).

The display apparatus 100 recognizes a related information storage interaction (S1120). In this case, the related information storage interaction includes a request to store related information regarding a screen or an object, and may be realized as a user motion or a user voice.

The display apparatus 100 generates query data based on the related information storage interaction (S1130), and transmits the generated query data to the related information providing server 200 (S1140).

The related information providing server 200 searches related information matching with the query data (S1150), and transmits the related information to the display apparatus 100 (S1160).

The display apparatus 100 stores the received related information (S1170).

Subsequently, the display apparatus 100 receives a related information list generating command (S1180). The display apparatus 100 displays the related information list (S1190).

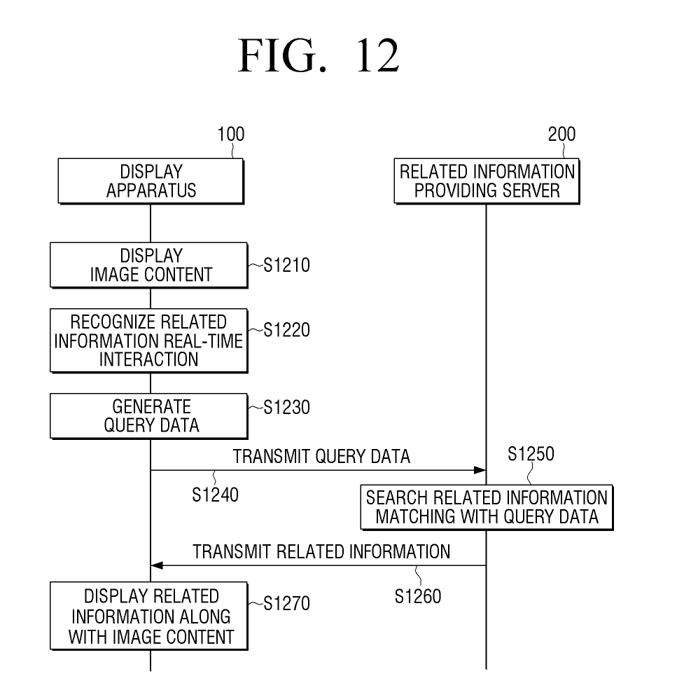

FIG. 12 is a sequence view provided to explain an exemplary embodiment where the information providing system 10 provides related information along with image content in real time.

First, the display apparatus 100 displays image content (S1210).

The display apparatus 100 recognizes a real-time related information interaction (S1220). In this case, the real-time related information interaction includes a request to provide related information regarding a screen or an object along with image content in real time, and may be realized as a user motion and a user voice.

The display apparatus 100 generates query data based on the real-time related information interaction (S1230), and transmits the generated query data to the related information providing server 200 (S1240).

The related information providing server 200 searches related information matching with the query data (S1250), and transmits the related information to the display apparatus 100 (S1260).

The display apparatus 100 displays the received related information along with image content (S1270).

As described above, according to the various exemplary embodiments, a user may obtain information related to a screen or an object of image content which is currently displayed more easily and intuitively.

In the above-described exemplary embodiment, at least one of a user motion and a user voice is used to obtain related information, but this is only an example, and related information may be obtained using a plurality of interactions. For example, in order to determine an object of interest, a pointer may be generated and moved according to a user motion, and an object of interest may be selected according to a user voice.

In addition, in the above-described example, a user interaction to obtain related information is a user motion and/or a user voice, but this is only an example. The related information may be obtained through various user interactions such as a remote controller, a pointing device, etc. For example, if a predetermined button of a remote controller is selected in order to obtain related information, the display apparatus 100 may generate query data regarding a screen at a time when the predetermined button is selected, and transmit the query data to the related information providing server 200.

According to the above-described various exemplary embodiments, a user may obtain information related to the screen or object of image content which is currently displayed more easily and intuitively.

The information providing method of a display apparatus according to the above-described various exemplary embodiments may be realized as a program and provided to the display apparatus or an input apparatus. For example, the program including the controlling method of a display apparatus may be stored in a non-transitory computer readable medium and provided therein.

The non-transitory computer readable medium may be a medium which may store data semi-permanently and may be readable by an apparatus. For example, the above-described various applications or programs may be stored and provided in a non-transitory recordable medium such as compact disc (CD), digital versatile disc (DVD), hard disk, Blu-ray disk, universal serial bus (USB), memory card, ROM, etc.

The foregoing embodiments and advantages are merely exemplary and are not to be construed as limiting the present disclosure. The present teaching can be readily applied to other types of apparatuses. Also, the description of the exemplary embodiments of the present inventive concept is intended to be illustrative, and not to limit the scope of the claims, and many alternatives, modifications, and variations will be apparent to those skilled in the art.

What is claimed is:

1. A method of providing information performed by a display apparatus, comprising:
displaying image content on a display screen of the display apparatus;
recognizing at least one of a user motion and a user voice to obtain information related to the image content while the image content is displayed;
generating query data according to the recognized at least one of the user motion and the user voice, and transmitting the query data to an external server; and
in response to receiving information related to the image content from the external server in response to transmitting the query data, providing the received related information.

2. The method of claim 1, wherein the transmitting comprises:
analyzing the recognized at least one of the user motion and the user voice, and determining an object of interest from one or more objects displayed on a display screen at a time when the at least one of the user motion and the user voice is recognized, about which related information is to be searched;
generating query data including information regarding the object of interest; and
transmitting the query data to the external server.

3. The method of claim 2, wherein the determining comprises, in response to a user voice to obtain information related to the image content being recognized, generating text data according to the user voice, and determining an object of interest about which related information is to be searched using the text data.

4. The method of claim 2, wherein the determining comprises:
in response to a first predetermined user motion being recognized, displaying a pointer on the display screen;
in response to a second predetermined user motion being recognized, moving the pointer according to a move command; and
in response to a third predetermined user motion being recognized after the pointer is placed on one of a plurality of objects displayed on the display screen, determining that the object where the pointer is positioned is an object of interest of which related information is to be searched.

5. The method of claim 1, wherein the providing comprises, in response to a request to provide the related information in real time being included in the recognized at least one of the user motion and the user voice, displaying the received related information along with the image content.

6. The method of claim 1, wherein the providing comprises, in response to a request to store the related information being included in the at least one of the recognized user motion and the user voice, storing the received related information; and
in response to a predetermined user command being input, displaying on the display screen a related information list including the stored related information.

7. The method of claim 1, comprising:
in response to an object containing a predetermined related information while the image content is displayed, displaying an informational message; and
in response to a user interaction using the informational message being recognized, transmitting query data requesting the predetermined related information to the external server.

8. The method of claim 1, comprising:
transmitting the received related information to an external mobile terminal.

9. The method of claim 1, wherein the query data includes at least one of information regarding a time when the at least one of the user motion and the user voice is recognized, information regarding a screen displayed when the at least one of the user motion and the user voice is recognized, and information regarding an audio output when the at least one of the user motion and the user voice is recognized,
wherein the external server analyzes the query data, searches related information corresponding to the query data, and transmits the searched related information corresponding to the query data to the display apparatus.

10. A display apparatus comprising:
a display configured to display image content;
a motion recognizer configured to recognize a user motion;
a voice recognizer configured to recognize a user voice;
a communicator configured to perform communication with an external server; and
a controller configured to, in response to at least one of the user motion and the user voice to obtain information related to the image content being recognized while the image content is displayed, control the communicator to generate query data according to the user motion and the user voice and transmit the query data to an external server, and in response to information related to the image content being received from the external server in response to the query data, provide the received related information.

11. The display apparatus of claim 10, wherein the controller controls the communicator to determine an object of interest from one or more objects displayed on a display screen at a time when the at least one of the user motion and the user voice is recognized, about which related information is to be searched by analyzing at least one of the recognized user motion and user voice, generate query data including information regarding the object of interest, and transmit the query data to the external server.

12. The display apparatus of claim 11, wherein the controller, in response to a user voice to obtain information related to the image content being recognized, generates text data according to the user voice, and determines an object of interest about which related information is to be searched using the text data.

13. The display apparatus of claim 11, wherein the controller, in response to a first predetermined user motion being recognized, controls the display to display a pointer on a display screen of the display, in response to a second predetermined user motion being recognized, moves the pointer according to a move command, and in response to a third predetermined user motion being recognized after the pointer is placed on one of a plurality of objects displayed on the display screen, determines that the object where the pointer is positioned as an object of interest about which related information is to be searched.

14. The display apparatus of claim 10, wherein the controller, in response to a request to provide the related information in real time being included in at least one of the user motion and the user voice, controls the display to display the received related information along with the image content.

15. The display apparatus of claim 10, further comprising:
a storage,
wherein the controller, in response to a request to store the related information being included in the recognized at least one of the user motion and the user voice, stores the received related information, and in response to a predetermined user command being input, controls the display to display a related information list including the stored related information.

16. The display apparatus of claim 10, wherein the controller, in response to an object containing a predetermined related information being recognized while the image content is displayed, controls the display to display an informational message, and in response to a user interaction using the informational message being recognized, controls the communicator to transmit query data requesting the predetermined related information to the external server.

17. The display apparatus of claim 10, wherein the controller controls the communicator to transmit the received related information to an external mobile terminal.

18. The display apparatus of claim 10, wherein the query data includes at least one of information regarding a time when the at least one of the user motion and the user voice is recognized, information regarding a screen displayed by the display when one of the user motion and user voice is recognized, and information regarding an audio output when the at least one of the user motion and the user voice is recognized,
wherein the external server analyzes the query data, searches related information corresponding to the query data, and transmits the searched related information corresponding to the query data to the display apparatus.

19. An apparatus for displaying information related to image content, the apparatus comprising:
a display configured to display the image content;
a controller configured to control the display to display information related to the image content on the display according to at least one of a user voice and a user motion being recognized.

20. The apparatus of claim 19, wherein the information related to the image content is at least one of image information, related music information, shopping information, image-related news information, social network information, and advertisement information.
